(19) United States
(12) Patent Application Publication
(10) Pub. No.: US 2016/0155068 A1
(43) Pub. Date: Jun. 2, 2016

(54) INFORMATION PROCESSING APPARATUS, INFORMATION PROCESSING METHOD, AND RECORDING MEDIUM FOR CLASSIFYING INPUT DATA

(71) Applicant: CANON KABUSHIKI KAISHA, Tokyo (JP)

(72) Inventor: Hirotaka Hachiya, Yokohama-shi (JP)

(21) Appl. No.: 14/949,491

(22) Filed: Nov. 23, 2015

(30) Foreign Application Priority Data
Nov. 28, 2014 (JP) 2014-242462

(51) Int. Cl. G06N 99/00; G06N 5/02

(52) U.S. Cl. CPC G06N 99/005; G06N 5/022

(57) ABSTRACT

A holding unit of an information processing apparatus holds a classification model and characteristic information for each of a plurality of groups acquired by dividing a plurality of feature values extracted from a plurality of training data pieces belonging to a specific class. Then, a feature extraction unit extracts a feature value from input data, and a selection unit selects one or more group(s) from the plurality of groups based on this extracted feature value and the characteristic information held by the holding unit. Then, a determination unit determines whether the input data belongs to the specific class with use of the classification model(s) corresponding to the selected group(s).

### BACKGROUND OF THE INVENTION

1. Field of the Invention

The present invention relates to a technique for classifying input data as a specific class.

2. Description of the Related Art

There is an issue regarding anomaly detection of determining whether data acquired by a sensor is abnormal. Approaches to this issue regarding the anomaly detection include modeling a normal range in a feature space from normal training data (normal data), and determining that determination target data is normal if the data is within the normal range while determining that the determination target data is abnormal if the data is outside the normal range.

In Hirotaka Hachiya and Masakazu Matsugu “NSH: Normality Sensitive Hashing for Anomaly Detection” (5th International Workshop on Video Event Categorization, Tagging and Retrieval (VECTaR2013) in 2013), a method that selects a plurality of linear classification models in such a manner that they do not divide the normal data and are not located far away from the normal data, in order to model the normal range, is discussed. According to this method, which side the determination target data is located with respect to each linear boundary can be determined by a simple calculation, whereby this method is expected to be implemented under a small-scale calculation environment, such as a monitoring camera.

However, in the anomaly detection method discussed in Hachiya and Matsugu, “NSH.”, a normal data range having a non-convex shape or constituted by a plurality of islands cannot be expressed by a combination of linear classification models, whereby this method involves a problem of being incapable of highly accurately detecting an anomaly.

### SUMMARY OF THE INVENTION

The present invention has been contrived with the aim of solving the above-described problem, and is directed to expressing a complicated normal data range with use of a classification model and achieving highly accurate classification.

According to an aspect of the present invention, an information processing apparatus comprises a feature extraction unit configured to extract a feature value from input data, a holding unit configured to, with respect to each of a plurality of groups acquired by dividing a plurality of feature values extracted from a plurality of training data pieces belonging to a specific class, hold characteristic information indicating a characteristic of a corresponding one of the plurality of groups, and a classification model, a selection unit configured to select at least one group from the plurality of groups held by the holding unit based on the extracted feature value of the input data and the characteristic information, and a determination unit configured to determine whether the input data belongs to the specific class with use of the classification model corresponding to the at least one group selected by the selection unit.

Further features of the present invention will become apparent from the following description of exemplary embodiments with reference to the attached drawings.

### BRIEF DESCRIPTION OF THE DRAWINGS

FIG. 1 is a configuration diagram illustrating an example of a configuration of an information processing apparatus according to a first exemplary embodiment.

FIG. 2 is a configuration diagram illustrating an example of a configuration of a linear classification model generation unit of the information processing apparatus according to the first exemplary embodiment.

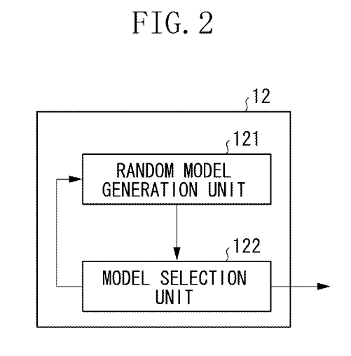

FIG. 3 illustrates a table indicating an example of information stored in a normal feature value storage unit (a feature value storage unit) according to the first exemplary embodiment.

FIG. 4 illustrates a table indicating an example of information stored in a data group storage unit according to the first exemplary embodiment.

FIG. 5 illustrates an example of information stored in a linear classification model storage unit according to the first exemplary embodiment.

FIG. 6 illustrates an example of a process in which determination target data is classified with use of local linear classification models according to the first exemplary embodiment.

FIG. 7 is a flowchart illustrating an example of an operation of the information processing apparatus according to the first exemplary embodiment regarding generation of the linear classification models.

FIG. 8 is a flowchart illustrating an example of an operation of the information processing apparatus according to the first exemplary embodiment.

FIG. 9 is a configuration diagram illustrating an example of a configuration of an information processing apparatus according to a second exemplary embodiment.

FIG. 10 is a configuration diagram illustrating an example of a configuration of a linear classification model generation unit of the information processing apparatus according to the second exemplary embodiment.

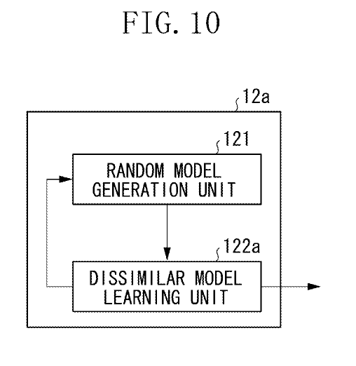

FIG. 11 illustrates an example of a process in which a plurality of linear classification models is learned with respect to a specific data group according to the second exemplary embodiment.

FIG. 12 is a flowchart illustrating an example of an operation of the information processing apparatus according to the second exemplary embodiment regarding generation of the linear classification models.

FIG. 13 is a configuration diagram illustrating an example of a configuration of an information processing apparatus according to a third exemplary embodiment.

FIG. 14 is a configuration diagram illustrating an example of a configuration of a linear classification model generation unit of the information processing apparatus according to the third exemplary embodiment.

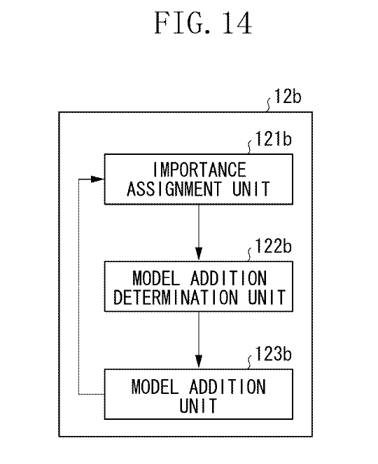

FIG. 15 illustrates an example of a process in which linear classification models are added with respect to a specific data group according to the third exemplary embodiment.

FIG. 16 is a flowchart illustrating an example of an operation of the information processing apparatus according to the third exemplary embodiment regarding generation of the linear classification models.

FIG. 17 illustrates an example of a hardware configuration of the information processing apparatuses according to the exemplary embodiments of the present invention.

### DESCRIPTION OF THE EMBODIMENTS

A first exemplary embodiment for embodying the present invention will be described with reference to the drawings. An anomaly detection system 1 according to the present exemplary embodiment sets, as normal data, data of a video image and the like captured by an imaging apparatus (for example, a camera) when a monitoring target is in a normal state, and learns local linear classification models that express a normal range in a feature space from the set data. Then, the anomaly detection system 1 specifies data of a video image and the like acquired by imaging a new state of the monitoring target, as determination target data (input data), and classifies the data as a normal class or an abnormal class locally in the feature space with use of the learned linear classification models. The anomaly detection system 1 determines whether there is an anomaly in the determination target data based on these results of the classification. Then, in a case where there is an anomaly, the anomaly detection system 1 issues a warning to a resident observer at a monitoring center, such as a security office. In the present exemplary embodiment, a specific class is assumed to correspond to the normal class, and a class outside the specific class is assumed to correspond to the abnormal class. Examples of this monitoring target include the outside and the inside of an ordinary home, and a public facility, such as a hospital and a train station.

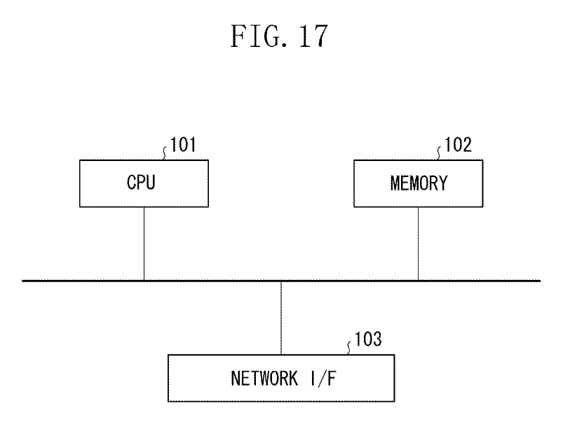

FIG. 17 illustrates an example of a hardware configuration of an information processing apparatus included in an anomaly detection system.

As illustrated in FIG. 17, the information processing apparatus according to exemplary embodiments of the present invention includes at least a central processing unit (CPU) 101, a memory 102, and a network interface (I/F) 103 as the hardware configuration. The CPU 101 controls the entire information processing apparatus. The CPU 101 performs processing based on a program stored in the memory 102, by which functions of a classification model generation device and the information processing apparatus that will be described below, and processing illustrated in flowcharts are realized. The memory 102 is a random access memory (RAM), a read only memory (ROM), a hard disk (HD), or the like, and stores the program, data that the CPU 101 uses when performing the processing, and the like. Storage units that will be described below are prepared in the memory 102. The network I/F 103 connects the information processing apparatus to a network and the like.

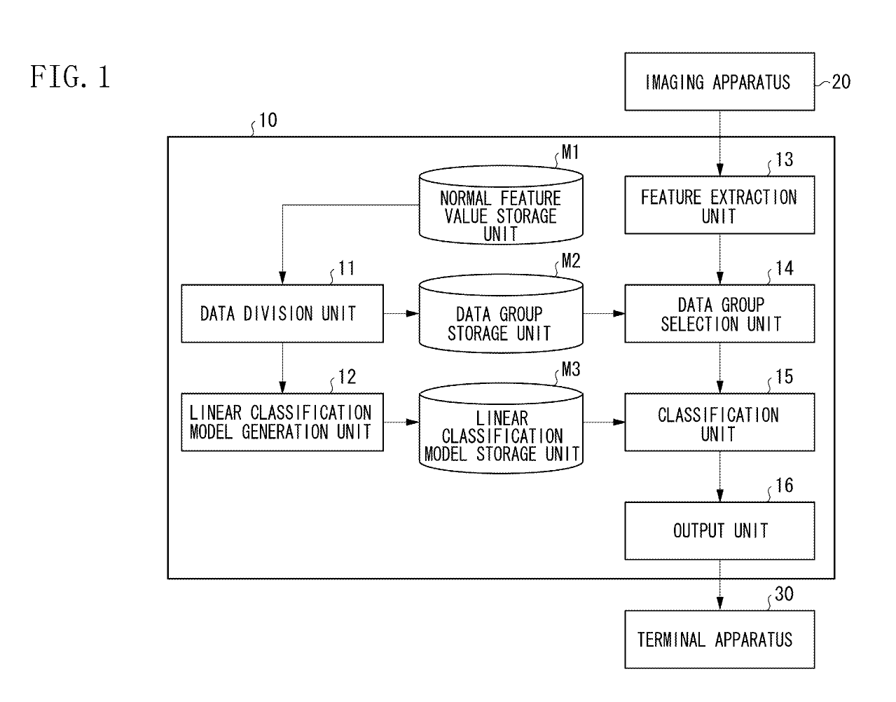

An imaging apparatus 20, a terminal apparatus 30, and the like also have at least a hardware configuration like the configuration illustrated in FIG. 1. Then, a CPU of each of these apparatuses performs processing based on a program stored in a memory of each of them, by which a function of each of the apparatuses and the like are realized. Further, the imaging apparatus 20 includes at least an image sensor and the like as the hardware configuration, besides the CPU and the memory. Further, the terminal apparatus 30 includes a display unit, such as a display, as the hardware configuration, besides the CPU and the memory.

FIG. 1 is a schematic block diagram illustrating an example of a configuration of the anomaly detection system using the information processing apparatus according to an exemplary embodiment of the present invention. The anomaly detection system 1 includes an information processing apparatus 10, the imaging apparatus 20, and the terminal apparatus 30, which are connected to one another via the network. For example, a mobile phone line network or the Internet can be used as the network.

Next, a detailed configuration of the information processing apparatus 10 will be described.

The information processing apparatus 10 is an apparatus that classifies the determination target data acquired by image capturing using the imaging apparatus 20 as the normal class or the abnormal class. The information processing apparatus 10 includes a normal feature value storage unit (a feature value storage unit) M1, a data group storage unit M2, a linear classification model storage unit M3, a data division unit 11, a linear classification model generation unit 12, a feature extraction unit 13, a data group selection unit 14, a classification unit 15, and an output unit 16.

The normal feature value storage unit (the feature value storage unit) M1 associates the normal data (the training data) with a normal data identification (ID) (feature value identification information) for identifying the normal data. Then, the normal feature value storage unit M1 stores a normal feature value indicating a feature value of the normal data belonging to the normal class, a data group ID for identifying a data group that the normal data belongs to, and scene information indicating an attribute of an environment under which the normal data is acquired. The normal data belonging to the normal class is data of a video image and the like of the monitoring target that is confirmed to be normal by a person in advance. Further, the normal feature value is information indicating a plurality of features of the monitoring target that is extracted from the normal data with use of a predetermined extraction method. The method for extracting the feature value will be described below in a description of the feature extraction unit 13 included in the information processing apparatus 10. Further, the data group that the normal data belongs to is automatically determined by the data division unit 11, which will be described below. Further, the scene information is a category selected from a plurality of categories prepared in advance according to the environment under which the data is acquired. For example, “morning”, “day”, “night”, and the like are prepared as categories in advance as the scene information regarding a period of time, and the category is selected according to the period of time during which the data is acquired.

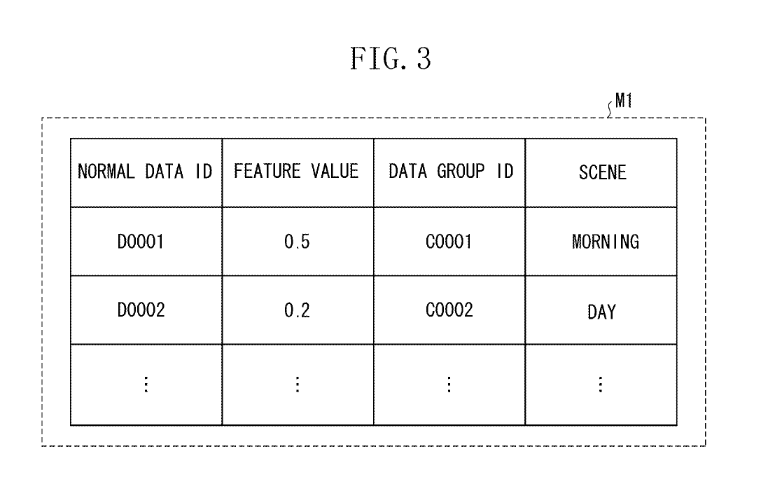

FIG. 3 illustrates a table indicating an example of the information stored in the normal feature value storage unit M1 according to the present exemplary embodiment. As illustrated in FIG. 3, the normal data ID is, for example, a character string including an alphabet and a number. For example, two data pieces are identified based on normal data IDs “D0001” and “D0002”. Then, FIG. 3 indicates that, for example, the normal data ID “D0001” is stored in such a manner that the normal data ID “D0001” is associated with a normal feature value “0.5”, a data group ID “C0001” for identifying the data group that the data belongs to, and the scene information “morning” indicating the environment under which the data is acquired.

The data group storage unit M2 stores, the data group ID for identifying the data group in such a manner that the data group ID is associated with data group characteristic information indicating a characteristic of the data group (a characteristic information setting). The data group characteristic information includes, for example, central coordinates of each data group in the feature space, a variance-covariance matrix indicating a shape of each data group, and/or the scene information of the normal data belonging to each data group.

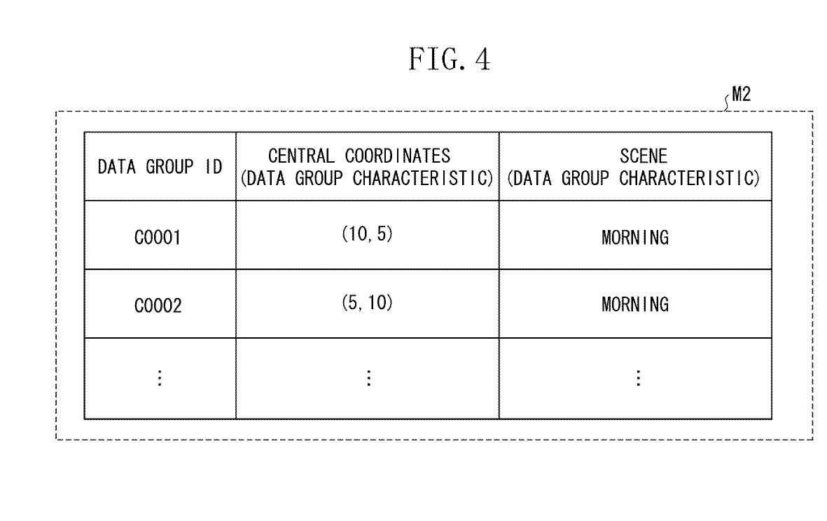

FIG. 4 illustrates a table indicating an example of the information stored in the data group storage unit M2 according to the present exemplary embodiment. As illustrated in FIG. 4, the data group ID is, for example, a character string including an alphabet and a number. For example, two data groups are identified based on “C0001” and “C0002”. Then, FIG. 4 indicates that, for example, the data group ID “C0001” is stored in such a manner that the data group ID “C0001” is associated with “(10, 5)”, which are the central coordinates of the data group (the data group characteristic information), and “morning”, which is the scene information of the data group (the data group characteristic information).

The linear classification model storage unit M3 stores (holds) a parameter indicating the linear classification model. More specifically, the linear classification model storage unit M3 stores the parameter of the linear classification model in such a manner that the parameter of the linear classification model is associated with the data group ID and a linear classification model ID for identifying the linear classification model. This parameter includes, for example, a normal vector w, a bias parameter b (refer to an expression (1)), and the like of the linear classification model generated by the linear classification model generation unit 12, which will be described below.

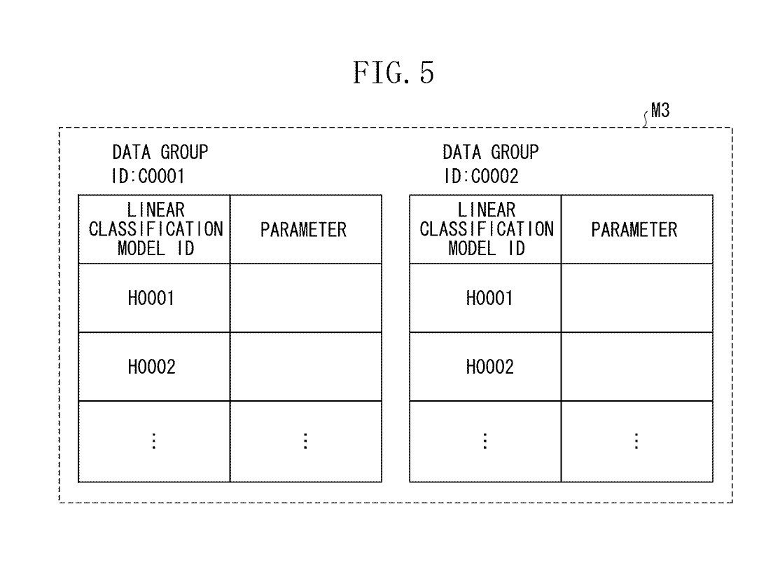

FIG. 5 illustrates tables indicating an example of the information stored in the linear classification model storage unit M3 according to the present exemplary embodiment. As illustrated in FIG. 5, the linear classification model ID is, for example, a character string including an alphabet and a number. For example, two linear classification models are identified based on “H0001” and “H0002”. Then, FIG. 5 indicates that there are tables associated with the data group IDs, and the parameter of the linear classification model is stored in each of the tables in such a manner that the parameter is associated with the linear classification model ID.

Referring back to FIG. 1, the configuration of the information processing apparatus 10 will be described.

The data division unit 11 divides the normal feature values stored in the normal feature value storage unit M1 into a plurality of data groups, and causes the data group storage unit M2 to store the data group characteristic information indicating the characteristic of each of the data groups in such a manner that the data group characteristic information is associated with the data group ID for identifying the data group. Along therewith, the data division unit 11 causes the normal feature value storage unit M1 to store the data group ID for identifying the data group that the normal data belongs to in such a manner that the data group ID is associated with the normal data ID. More specifically, the data division unit 11 reads in the normal feature values from the normal feature value storage unit M1. Next, the data division unit 11 divides the read normal feature values into as many data groups as a predetermined number C of data groups. A known method, such as k-means clustering, sparse coding, and a contaminated normal distribution, is used as a method for dividing the data.

In the case where the k-means clustering or the sparse coding is used as the method for dividing the data, the data group characteristic information includes the central coordinates of the data group. On the other hand, in the case where the contaminated normal distribution is used as the method for dividing the data, the data group characteristic information includes the variance-covariance matrix indicating the shape of the data group, in addition to the central coordinates of the data group. The data division unit 11 may divide the normal data based on a kind of the scene information indicating the environment under which the normal data is acquired. More specifically, the scene information may be included as the data group characteristic. For example, if the normal data pieces each having “morning”, “day”, or “night” as the scene information are individually divided into two data groups, the normal data pieces are divided into six data groups in total.

Next, the data division unit 11 causes the data group storage unit M2 to store the data group characteristic information in such a manner that the data group characteristic information is associated with the data group ID, and also causes the normal feature value storage unit M1 to store the data group ID of the data group that the normal data belongs to in such a manner that the data group ID is associated with the normal data ID. Along therewith, the data division unit 11 outputs a trigger to the linear classification model generation unit 12. The data group ID may be determined based on an order in which the data groups are generated. In this case, for example, the data group ID of the data group generated second is set to “C0002”.

The linear classification model generation unit 12 includes a random model generation unit 121 and a linear classification model selection unit 122. The linear classification model generation unit 12 generates a plurality of linear classification models for classifying the determination target data as the normal class or the abnormal class for each of the data groups based on the normal feature values stored in the normal feature value storage unit M1. Then, the linear classification model generation unit 12 causes the linear classification model storage unit M3 to store each of the generated linear classification models in such a manner that each of the generated linear classification models is associated with the linear classification model ID for identifying the linear classification model, and the data group ID for identifying the data group that the linear classification model belongs to. The linear classification model ID may be determined based on an order in which the linear classification models are generated. In this case, for example, the linear classification model ID of the linear classification model generated second is set to “H0002”.

The linear classification model is expressed as a hyperplane in the feature space. The feature space is a space including a vector of feature values as an element thereof. Then, the hyperplane is set as a boundary, and a feature value located in a region positioned in a direction of a normal vector is classified as the normal class while a feature value located on an opposite side therefrom is classified as the abnormal class. For example, an m-th linear classification model (a linear classification model ID: H000m) is expressed as the following expression (1):

wₘ^{T}x−bₘ=0 (1)

where T represents a transpose of a vector, x represents the feature vector having one feature value as each element, w represents the normal vector of the hyperplane, and b represents the bias. In other words, parameters of the m-th linear classification model correspond to (wₘ, bₘ).

The random model generation unit 121 randomly generates candidates for the linear classification models for each of the data groups according to a predetermined probability distribution. The probability distribution used to generate the candidates for the linear classification models may be set based on the data group characteristic information. More specifically, the random model generation unit 121 randomly generates as many pairs of parameters (w, b) as a predetermined number L of candidates according to the predetermined probability distribution, in response to the input of the trigger from the data division unit 11. A normal distribution or a uniform distribution is used as the probability distribution. This probability distribution may be set based on the data group characteristic information. For example, central coordinates and a variance-covariance matrix of the normal distribution may be set as the central coordinates and the variance-covariance matrix of the data group that are included in the data group characteristic information.

The model selection unit 122 selects, from the candidates for the linear classification models for each of the data groups that are generated by the random model generation unit 121, linear classification models that allow the normal data belonging to the data group to be classified as the normal class, and a density of the normal data classified as the normal class to exceed a predetermined value. For example, the model selection unit 122 evaluates each of the linear classification models with use of the following evaluation expression equivalent to an objective function of a one-class support vector machine:

$$\frac{1}{N} {\sum }_{n = 1}^{N} L ( {w}_{m}^{T} {x}_{n} - {b}_{m} ) - λ {b}_{m} , \qquad ( 2 )$$

where N represents the number of normal data pieces belonging to the data group, and λ represents a bias importance parameter. Further, L(z) represents a function expressing an error when the normal data is determined to be abnormal, and is, for example, defined in the following manner:

$$L ( z ) ≡ \{ \begin{matrix}0 & ( z \geq 0 ) \\ {z}^{2} & ( z < 0 )\end{matrix} . \qquad ( 3 )$$

In other words, the function L(z) has the following nature. In a case where the normal feature value is located in the region positioned in the direction of the normal vector with respect to the hyperplane, a value of the function L(z) equals 0. On the other hand, in a case where the normal feature value is located in a region positioned in an opposite direction of the normal vector with respect to the hyperplane, the value of the function L(z) has a positive value proportional to a distance from the hyperplane. In other words, a value of a first term of the expression (2) is small for the hyperplane that allows as many normal feature values as possible to be located in the region positioned in the direction of the normal vector with respect to the hyperplane.

On the other hand, in a case where a value of the bias parameter b in a second term of the expression (2) equals 0, the hyperplane passes through an origin of the feature value space. Then, as the value increases, the hyperplane translates in the direction of the normal vector. On the other hand, as the value reduces (for example, shifts to a negative value), the hyperplane translates in the opposite direction of the normal vector. The bias importance parameter λ can relatively adjust a degree of influence of the bias parameter b in the second term relative to the first term of the expression (2). A value of λ is set by a person in advance. The value of λ may be automatically set with use of a model selection method, such as cross-validation.

Then, the model selection unit 122 selects as many linear classification models (pairs of parameters w and b) as a predetermined number M that minimize the expression (2) from the L candidates for the linear classification models.

The linear classification model generation unit 12 causes the linear classification model storage unit M3 to store each of the plurality of linear classification models generated for each of the data groups in such a manner that each of the plurality of linear classification models is associated with the data group ID for identifying the data group and the linear classification model ID.

Referring back to FIG. 1, the configuration of the information processing apparatus 10 will be described.

The imaging apparatus 20 includes a camera for imaging image data or video data regarding the monitoring target. The imaging apparatus 20 may include a microphone for inputting a sound and a voice of the monitoring target, a thermometer for measuring a temperature, a distance sensor for measuring a distance, or the like. The imaging apparatus 20 transmits the determination target data, which is the data or the like acquired by capturing video image, to the information processing apparatus 10 via the network. The imaging apparatus 20 may be equipped therein with a sensor for measuring meta information of the environment under which the determination target data is acquired, and add the measured meta information into the determination target data. For example, the imaging apparatus 20 includes a clock therein, and adds a time at which the data is acquired into the determination target data.

The feature extraction unit 13 extracts the feature value from the determination target data acquired by the imaging apparatus 20. More specifically, the determination target data is output from the imaging apparatus 20 to the feature extraction unit 13 via the network at a predetermined time interval. The feature extraction unit 13 outputs a determination target feature value, which is generated by converting the acquired determination target data into the feature value by a predetermined method for extracting the feature value, together with the meta information contained in the acquired determination target data to the data group selection unit 14 according to the acquisition of the determination target data. The determination target data is configured so as to have a predetermined length and a predetermined frame rate. For example, the length is 5 seconds, and the frame rate is 3 fps. Then, for example, a known method, such as a histogram of oriented gradient (HOG), a histogram of optical flow (HOF), a multi-scale histogram of optical flow (MHOF), and a scale invariant feature transform (SIFT) that extract a local feature in each frame of the video image, is used as the method for extracting the feature value.

These methods for extracting the feature may be used on each region defined by dividing each frame in the video image into a plurality of regions. The method for extracting the feature value may be specialized in a specific monitoring target. For example, in a case where the monitoring target is a person, the method for extracting the feature value may be a method for extracting a posture, a movement trail, and the like of the person as the feature value.

The data group selection unit 14 selects a data group or data groups that the determination target data belongs to based on a relationship between the determination target feature value and the data group characteristic information. The data group selection unit may select the data group(s) that the determination target data belongs to based on a relationship between the scene information indicating the environment under which the determination target data is acquired and the data group characteristic information, in addition to the determination target feature value. More specifically, the data group selection unit 14 selects a category of a scene in which the determination target data is acquired as the scene information based on the meta information according to the inputs of the determination target feature value and the meta information from the feature extraction unit 13. More specifically, the data group selection unit 14 selects the category from the categories prepared in advance according to the meta information. For example, the data group selection unit 14 selects the category (“morning”, “day”, or “night”) of the scene that corresponds to the period of time according to information indicating the time at which the data is acquired, which is contained in the meta information. Then, the data group selection unit 14 selects one data group or a plurality of data groups that the determination target feature value belongs to based on the relationships between the input determination target feature value and the selected scene information, and the data group characteristic information stored in the data group storage unit M2. Examples of a method for selecting the data group(s) include the following three methods.

As a first method for selecting the data group(s), the data group selection unit 14 selects all data groups having the scene information that matches the scene information of the determination target data. More specifically, the data group selection unit 14 selects all data groups associated with the data group characteristic information including the scene information that matches the scene information of the determination target data.

As a second method for selecting the data group(s), the data group selection unit 14 selects a data group or data groups located in the vicinity of the determination target feature value. More specifically, the data group selection unit 14 selects a data group or data groups associated with the data group characteristic information including central coordinates located away from the classification target feature value by a distance shorter than a predetermined threshold value.

As a third method for selecting the data group(s), the data group selection unit 14 selects a data group or data groups that match(es) the scene information of the determination target data, and is or are also located in the vicinity of the determination target data. More specifically, the data group selection unit 14 selects a data group or data groups associated with the data group characteristic information including central coordinates located away from the determination target feature value by a distance shorter than a predetermined threshold value, among the data groups associated with the data group characteristic information including the scene information that matches the scene information of the determination target data.

In the second and third methods for selecting the data group(s), the Mahalanobis distance, which uses a variance-covariance matrix as a metric in distance measurement, may be employed, in the case where the variance-covariance matrix is included in the data group characteristic information.

The data group selection unit 14 outputs the data group ID(s) for identifying the selected data group(s), and the determination target feature value to the classification unit 15.

The classification unit 15 reads in the parameters of the linear classification models associated with the data group ID(s) for identifying the data group(s) selected by the data group selection unit 14 from the linear classification model storage unit M3. Then, the classification unit 15 determines which class the determination target feature value belongs to, the normal class or the abnormal class, with use of the read linear classification models. Then, the classification unit 15 outputs classification result information, which indicates a result of the classification, to the output unit 16. More specifically, the classification unit 15 inputs the data group ID(s) and the determination target feature value from the data group selection unit 14, and also reads in the parameters of the plurality of linear classification models stored in and associated with the input data group ID from the linear classification model storage unit M3 for each of the data groups. Then, the classification unit 15 classifies the input determination target feature value as the normal class or the abnormal class with use of the parameters of the read linear classification models for each of the data groups. As a method for the classification, for example, for each of the data groups, in a case where the number of linear classification models that allow the determination target data to be classified as the normal class among the plurality of linear classification models is larger than a predetermined threshold value, the classification unit 15 classifies the determination target data as the normal class in terms of the data group. Then, in a case where the determination target data is classified as the normal class in terms of any of the data groups, the classification unit 15 classifies the determination target data as the normal class. Then, the classification unit 15 outputs the classification result information, which indicates whether the determination target data belongs to the normal class or the abnormal class, to the output unit 16. This classification result information is set to, for example, a value of “−1” in a case where the determination target data is abnormal, and a value of “1” in a case where the determination target data is normal.

The output unit 16 generates display information regarding the video data based on the classification result information, and outputs the generated display information. More specifically, the output unit 16 inputs the classification result information from the classification unit 15, and also inputs the video data from the imaging apparatus 20. Then, the output unit 16 generates the display information of the input video image based on the input classification result information, and outputs the generated display information to the terminal apparatus 30 via the network. In a case where the classification result information indicates that there is no anomaly in the video data (for example, the classification result information is set to “1”), this display information is, for example, the video data as originally input, or video data generated by reducing a resolution or a frame rate of the input video data. On the other hand, in a case where the classification result information indicates that there is an anomaly in the video data (for example, the classification result information is set to “−1”), the display information includes warning information for alerting the observer in addition to the video data. This warning information is, for example, a text or a voice such as “Anomaly Detected”.

The terminal apparatus 30 is a computer apparatus that the observing user uses, and presents the display information supplied from the information processing apparatus 10 via the network. Although being not illustrated, the terminal apparatus 30 includes a display unit 41. For example, a personal computer (PC), a tablet PC, a smart-phone, a feature phone, or the like can be used as the terminal apparatus 30. More specifically, the terminal apparatus 30 acquires the display information according to the output of the display information from the information processing apparatus 10. Then, the terminal apparatus 30 outputs the acquired display information to the display unit 41.

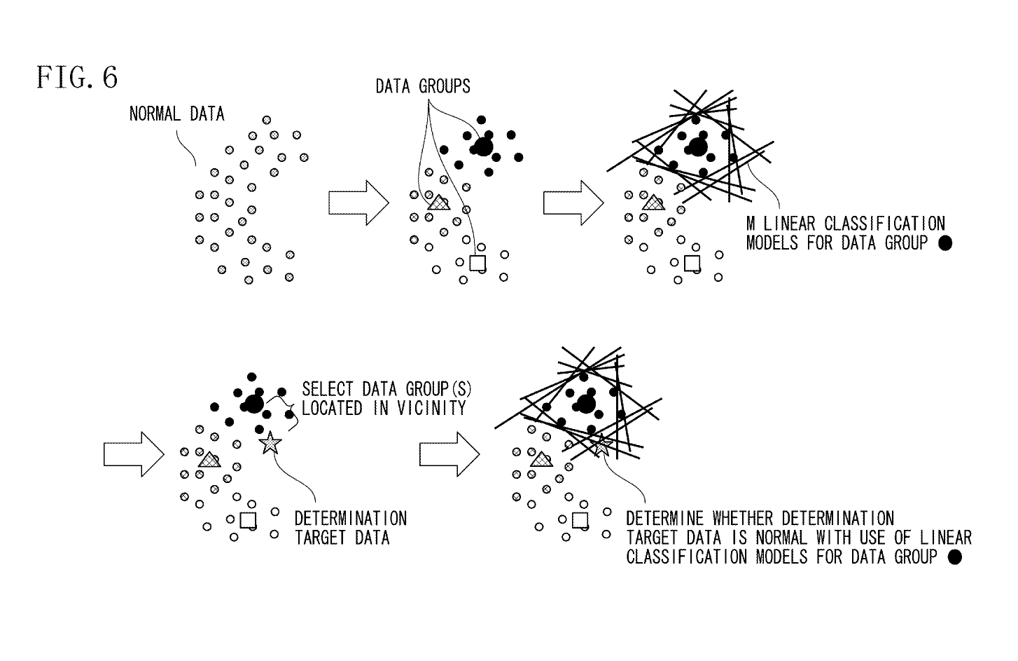

FIG. 6 illustrates an example of a process in which the information processing apparatus 10 classifies the determination target data with use of the local linear classification models. As illustrated in FIG. 6, first, the information processing apparatus 10 divides the normal data into the plurality of data groups. Next, the information processing apparatus 10 selects the M linear classification models from the linear classification models randomly generated for each of the data groups with use of the evaluation expression indicated as the expression (2). When being provided with the determination target data, the information processing apparatus 10 selects the data group(s) located in the vicinity, and determines whether the determination target data is normal with use of the linear classification models of this or these data group(s).

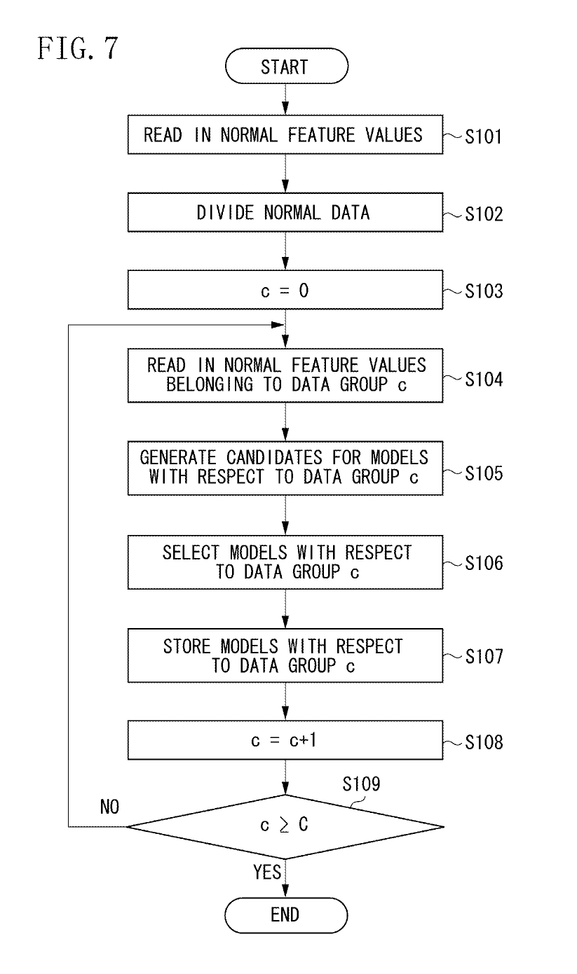

Next, an operation of the information processing apparatus 10 according to the present exemplary embodiment will be described with reference to FIG. 7. FIG. 7 is a flowchart illustrating an example of an operation of the information processing apparatus 10 according to the present exemplary embodiment for generating the linear classification models.

In step S101, the data division unit 11 reads in the normal feature values from the normal feature value storage unit M1.

In step S102, the data division unit 11 divides the normal data. More specifically, the data division unit 11 divides the read normal data with use of the above-described predetermined method, and causes the data group storage unit M2 to store the data group characteristic information in such a manner that the data group characteristic information is associated with the data group ID. Further, the data division unit 11 causes the normal feature value storage unit M1 to store the data group ID of the data group that the data belongs to in such a manner that the data group ID of the data group is associated with the normal data ID. Then, the data division unit 11 outputs the trigger to the linear classification model generation unit 12.

In step S103, the linear classification model generation unit 12 resets a data group counter c. More specifically, the linear classification model generation unit 12 sets the data group counter c to “0” according to the input of the trigger from the data division unit 11.

In step S104, the linear classification model generation unit 12 reads in the normal data belonging to a data group c. More specifically, the linear classification model generation unit 12 reads in the normal feature values associated with the data group ID for identifying the data group c from the normal feature value storage unit M1.

In step S105, the random model generation unit 121 randomly generates the candidates for the linear classification models with respect to the data group c. More specifically, the random model generation unit 121 randomly generates as many pairs of parameters (w, b) as the predetermined number L of candidates.

In step S106, the linear classification model selection unit 122 selects the linear classification models with respect to the data group c. More specifically, the linear classification model selection unit 122 selects the parameters of the M linear classification models that minimize the expression (2) from the candidates generated by the random model generation unit 121.

In step S107, the linear classification model generation unit 12 causes the linear classification model storage unit M3 to store the parameters of the generated linear classification models. More specifically, the linear classification model generation unit 12 causes the linear classification model storage unit M3 to store the parameters of each of the generated linear classification models in such a manner that the parameters are each associated with the data group ID for identifying the data group c and the linear classification model ID for identifying the linear classification model.

In step S108, the linear classification model generation unit 12 adds “1” to the data group counter c.

In step S109, the linear classification model generation unit 12 determines whether the data group counter c is the predetermined number C of data groups, or larger. More specifically, in a case where the data group counter c is predetermined number C of data groups or larger (YES in step S109), the processing ends. On the other hand, if the data group counter c is smaller than predetermined number C of data groups (NO in step S109), the processing returns to step S104.

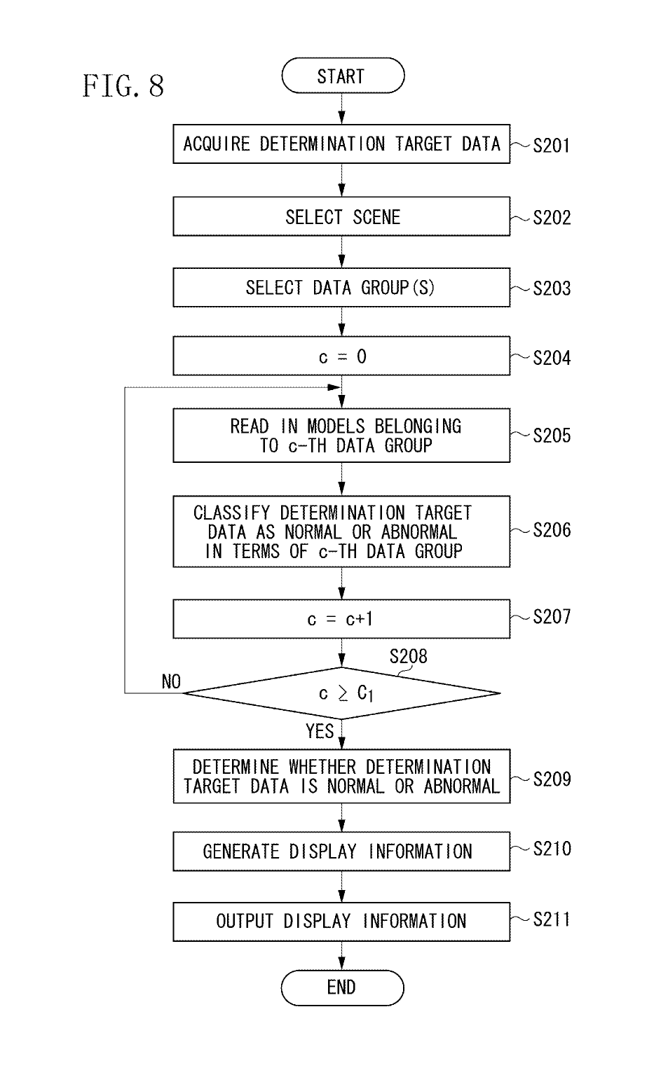

Next, FIG. 8 is a flowchart illustrating an example of an operation of the information processing apparatus 10 according to the present exemplary embodiment for the classification.

In step S201, the feature extraction unit 13 acquires the determination target data from the imaging apparatus 20. More specifically, the determination target data acquired by imaging using the imaging apparatus 20 is output to the feature extraction unit 13 and the output unit 16 via the network. The feature extraction unit 13 extracts the determination target feature value from the acquired determination target data with use of the above-described predetermined method for extracting the feature according to the acquisition of the determination target data. Then, the feature extraction unit 13 outputs the extracted determination target feature value and the meta information contained in the determination target data to the data group selection unit 14.

In step S202, the data group selection unit 14 selects the scene information of the determination target data. More specifically, the data group selection unit 14 selects the category indicating the environment under which the determination target data is acquired as the scene information from the predetermined categories prepared in advance based on the input meta information according to the inputs of the determination target feature value and the meta information from the feature extraction unit 13.

In step S203, the data group selection unit 14 selects the data group(s) based on the relationships between the determination target feature value and the selected scene information, and the data group characteristic information. More specifically, the data group selection unit 14 reads in the data group characteristic information that is stored in the data group storage unit M2 and associated with the data group ID. Then, the data group selection unit 14 selects the data group(s) that the determination target data belongs to based on the input determination target feature value and the selected scene information, and the read data group characteristic information with use of the above-described predetermined method for selecting the data group(s). Then, the data group selection unit 14 outputs the data group ID(s) for identifying the selected data group(s) and the input determination target feature value to the classification unit 15.

In step S204, the classification unit 15 resets the counter c for the number of data groups. More specifically, the classification unit 15 sets the counter c for the number of data groups to “0” according to the inputs of the data group ID(s) and the determination target feature value from the data group selection unit 14.

In step S205, the classification unit 15 reads in the parameters of the linear classification models associated with a c-th data group. More specifically, the classification unit 15 reads in the parameters of all of the linear classification models associated with the data group ID for identifying the c-th data group from the linear classification model storage unit M3.

In step S206, the classification unit 15 classifies the determination target data as the normal class or the abnormal class in terms of the c-th data group. More specifically, the classification unit 15 classifies the input determination target feature value as the normal class or the abnormal class in terms of the c-th data group by the above-described predetermined classification method with use of the read linear classification models.

In step S207, the classification unit 15 adds “1” to the counter c.

In step S208, the classification unit 15 determines whether the counter c is a number C₁ of data groups input from the data group selection unit 14, or larger. More specifically, in a case where the counter c is the number C₁ of data groups or larger (YES in step S208), the processing proceeds to step S209. On the other hand, in a case where the counter c is smaller than the number C₁ of data groups (NO in step S208), the processing returns to step S205.

In step S209, the classification unit 15 determines whether the determination target data is normal. More specifically, the classification unit 15 determines that the determination target data is normal, in a case where the determination target data is classified as the normal class in terms of even a single data group among the C₁ data groups. On the other hand, the classification unit determines that the determination target data is abnormal, in a case where the determination target data is not classified as the normal class in terms of even a single data group among the C₁ data groups. Then, the classification unit 15 outputs the information indicating the result of the determination to the output unit 16.

In step S210, the output unit 16 outputs the display information to the terminal apparatus 30. More specifically, the output unit 16 outputs the display information, which is generated based on the classification result information input from the classification unit 15 and the determination target data input from the imaging apparatus 20, to the terminal apparatus 30 via the network.

In step S211, the terminal apparatus 30 outputs the display information. Then, the processing ends. More specifically, the terminal apparatus 30 outputs the display information input from the output unit 16 of the information processing apparatus 10 to the display unit 41.

In this manner, in the first exemplary embodiment, the determination target data is classified with use of the local linear classification models corresponding to the data group(s) located in the vicinity of the determination target feature value. As a result, an anomaly can be detected highly accurately even when the normal data region has a non-convex shape or is constituted by a plurality of islands.

The classification unit 15 classifies the determination target data as to whether the data belongs to the specific class for each of the data group(s) selected by the data group selection unit 14, and determines that the determination target data belongs to the specific class in a case where classifying the determination target data as belonging to the specific class in terms of any of the data group(s).

Therefore, the information processing apparatus can carry out multiple checks on whether the determination target data is normal in terms of the plurality of data groups located in the vicinity of the determination target data, and therefore can detect an anomaly robustly against a noise contained in the determination target data.

The feature value includes the scene information indicating the environment under which the data is acquired, and the data division unit 11 divides the feature values for each kind of the scene information and adds the scene information into the data group characteristic information. Then, the data group selection unit 14 selects the scene information indicating the environment under which the determination target data is acquired, adds the scene information to the determination target feature value converted by the feature extraction unit 13, and selects the data group(s) that the determination target feature value belongs to based on the relationship with the data group characteristic information.

Therefore, the information processing apparatus can model the normal range for each of various situations (scenes) under which the determination target data might be acquired, and therefore can avoid an issue of a reduction in a performance of detecting an anomaly due to presence of different situations in a mixed state.

Next, a second exemplary embodiment for embodying the present invention will be described with reference to the drawings. Similar components to the individual components in the above-described first exemplary embodiment will be identified by the same reference numerals, and descriptions thereof will be omitted.

An anomaly detection system 1a according to the present exemplary embodiment will be described based on an example that uses multi-task learning to set the parameters of the linear classification models for each of the data groups. In other words, an information processing apparatus 10a according to the present exemplary embodiment is different from the first exemplary embodiment in terms that the information processing apparatus 10a uses the learning to set the parameters of the linear classification models for each of the data groups. In the present exemplary embodiment, the specific class is assumed to correspond to the normal class, and the class outside the specific class is assumed to correspond to the abnormal class, similarly to the first exemplary embodiment.

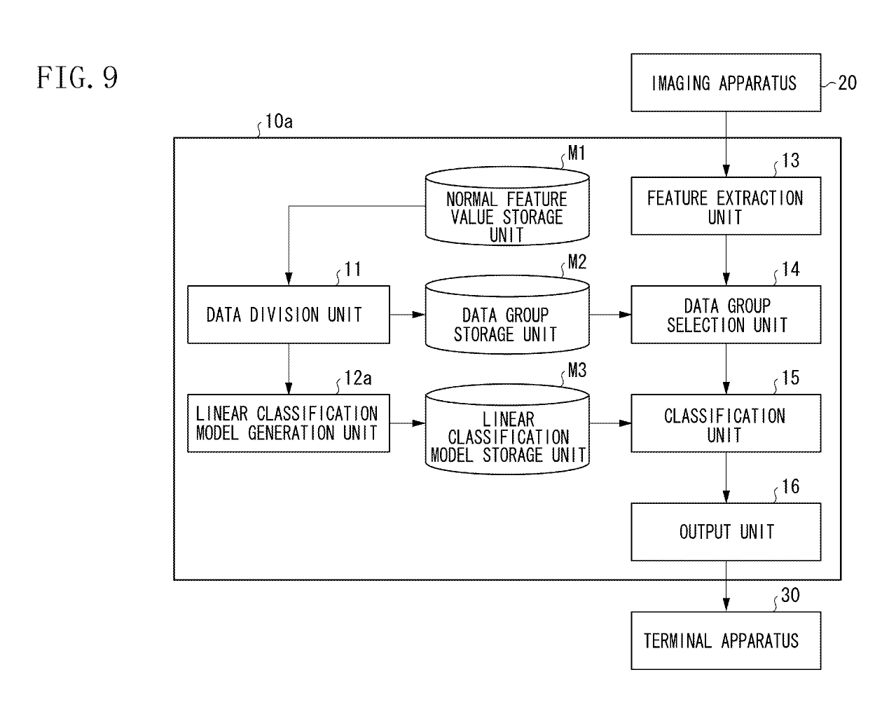

FIG. 9 is a configuration diagram illustrating an example of a configuration of the anomaly detection system 1a according to the second exemplary embodiment of the present invention. The anomaly detection system 1a includes the information processing apparatus 10a, the imaging apparatus 20, and the terminal apparatus 30, which are connected to one another via a network.

The information processing apparatus 10a is different from the information processing apparatus 10 according to the first exemplary embodiment in terms that the information processing apparatus 10a includes a linear classification model generation unit 12a.

The linear classification model generation unit 12a includes the random model generation unit 121 and a dissimilar model learning unit 122a. The linear classification model generation unit 12a generates a plurality of linear classification models for classifying the determination target data as the normal class or the abnormal class for each of the data groups based on the normal feature values stored in the normal feature value storage unit M1. Then, the linear classification model generation unit 12a causes the linear classification model storage unit M3 to store each of the generated linear classification models in such a manner that each of the generated linear classification models is associated with the linear classification model ID for identifying the linear classification model and the data group ID for identifying the data group that the linear classification model belongs to.

The dissimilar model learning unit 122a learns the plurality of linear classification models for each of the data groups that is generated by the random model generation unit 121, one by one under the following conditions also in consideration of a degree of similarity between the linear classification models. These conditions are to allow the normal data belonging to the data group to be classified as the normal class, to enable the density of the normal data classified as the normal class to exceed a predetermined value, and to be not similar to already learned another linear classification model in the same data group. For example, the dissimilar model learning unit 122a optimizes the parameters of the m-th linear classification model expressed as the expression (1) so as to minimize the following objective function of the one-class support vector machine that includes a similarity penalty term:

$${min}_{{w}_{m} , {b}_{m}} \frac{1}{2} {‖ {w}_{m} ‖}^{2} - {b}_{m} + D {\sum }_{n = 1}^{N} {ξ}_{n} + \frac{1}{2} {\sum }_{{m}^{′} = 1}^{m - 1} J ( {w}_{m} , {w}_{{m}^{′}} ) \\ s . t . \\ {w}_{m}^{T} {x}_{n} \geq {b}_{m} - {ξ}_{n} \\ n = 1 , 2 , … , N , \\ {ξ}_{n} \geq 0 \qquad ( 4 )$$

where (wₘ, bₘ) represent the parameters of the m-th linear classification model. Further, D represents a hyper-parameter of importance assigned to an error in classifying the normal data as the normal class. Further, J(wₘ, w_{m′}) in a fourth term represents a similarity penalty between the normal vectors wₘ, w_{m′} of the two linear classification models. For example, the similarity penalty is defined in the following manner:

J(wₘ,w_{m′})=wₘ^{T}w_{m′} (5).

The function J(wₘ, w_{m′}) has the following nature. In a case where the normal vectors wₘ and w_{m′} point in a same direction, a value of the function J(wₘ, w_{m′}) is maximized. In a case where the normal vectors wₘ and w_{m′} intersect at right angles, the value of the function J(wₘ, w_{m′}) equals “0”. In a case where the normal vectors wₘ and w_{m′} point in opposite directions, the value of the function J(wₘ, w_{m′}) is minimized. In other words, as the two normal vectors wₘ and w_{m′} become more similar to each other, the value of the function J(wₘ, w_{m′}) increases. As such, minimizing the entire objective function expression (4) results in an increase in the number of normal feature values classified as the normal class (corresponding to a third term of the expression (4)) with respect to the m-th linear classification model. Further, the parameters can be optimized so as to allow the hyperplane to approach the normal feature vector (corresponding to a second term of the expression (4)), and prevent the linear classification model from resembling already optimized models from a first model to an (m−1)-th model (corresponding to the fourth term of the expression (4)). The fourth term equals “0” with respect to the first linear classification model (m=1). Further, as an optimization method, for example, the optimum parameters satisfying the expression (5) can be determined in the following manner, similarly to the one-class support vector machine. That is, a dual problem acquired by transforming the objective function expressed as the expression (5) with use of the method of Lagrange multipliers and the Karush-Kuhn-Tucker conditions can be sequentially solved with use of, for example, the steepest descent method. When an amount of an update of the parameters falls to or below a predetermined threshold value for the update amount that is prepared in advance or the number of times of the update reaches or exceeds a predetermined threshold value for the number of times that is prepared in advance in each iteration of the steepest descent method, the update of the parameters by the steepest descent method is ended.

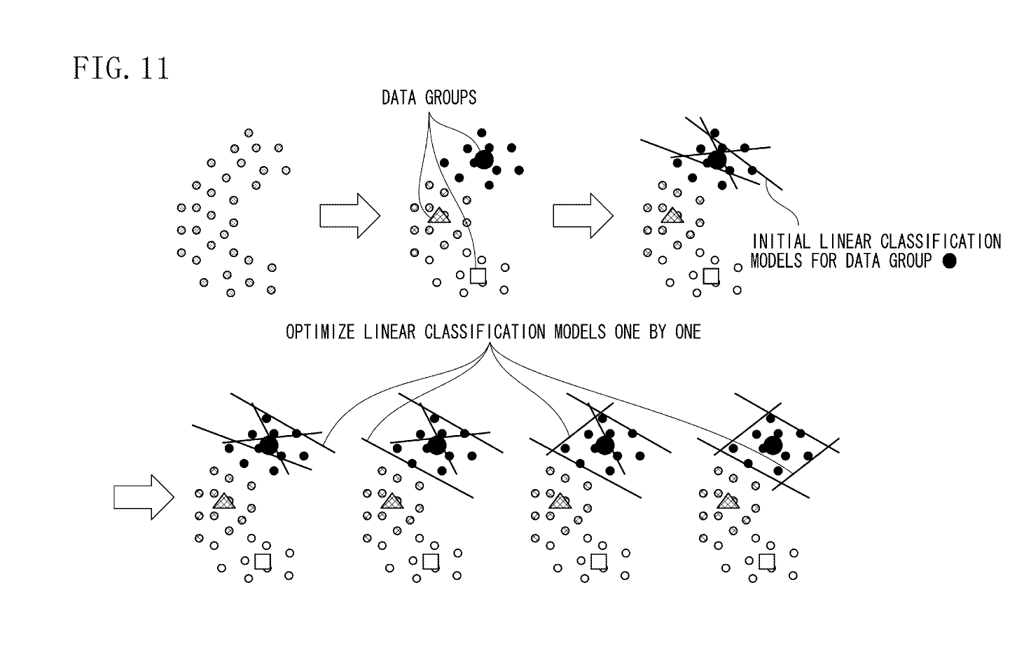

FIG. 11 illustrates an example of a process in which the information processing apparatus 10a learns the plurality of linear classification models with respect to a specific data group. As illustrated in FIG. 11, first, the information processing apparatus 10a divides the normal data into the plurality of data groups. Next, the information processing apparatus 10a sequentially learns the linear classification models randomly generated for each of the data groups by solving the optimization problem expressed as the expression (4).

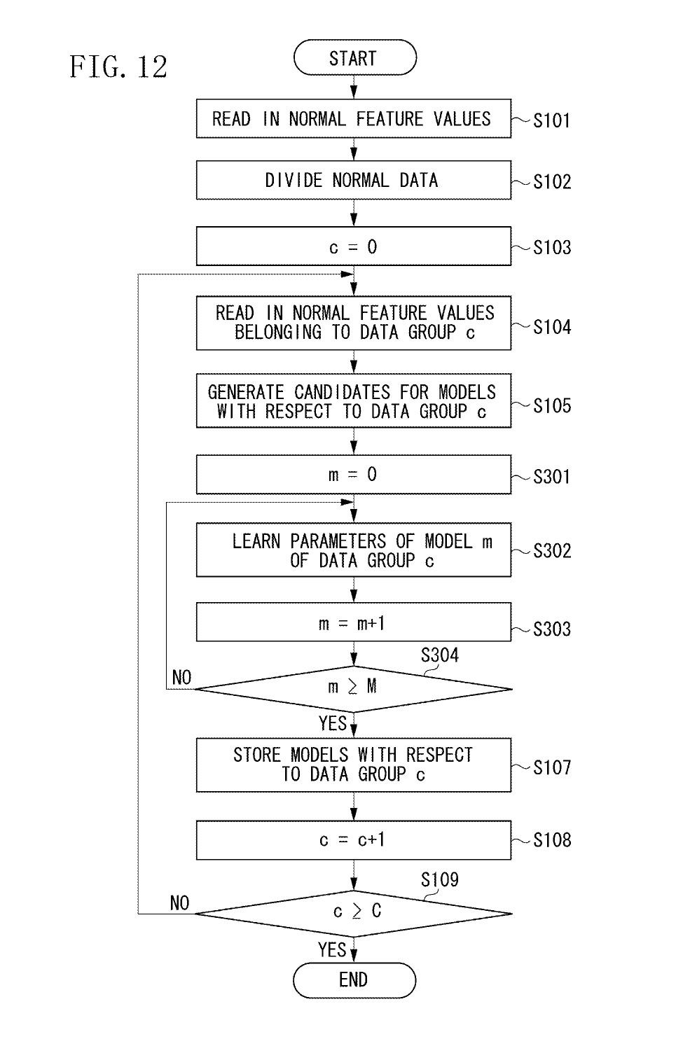

Next, an operation of the information processing apparatus 10a in the anomaly detection system 1a will be described with reference to FIG. 12. FIG. 12 is a flowchart illustrating an example of an operation of the information processing apparatus 10a according to the present exemplary embodiment for generating the linear classification models. Similar operations to the first exemplary embodiment will be identified by the same step numbers, and descriptions thereof will be omitted.

In step S301, the dissimilar model learning unit 122a resets a model counter m. More specifically, the dissimilar model learning unit 122a sets the model counter m to “0”.

In step S302, the dissimilar model learning unit 122a learns the m-th linear classification model with respect to the data group c. More specifically, the dissimilarity model learning unit 122a optimizes the parameters of the m-th linear classification model with respect to the data group c with use of the above-described steepest descent method so as to satisfy the expression (4).

In step S303, the dissimilar model learning unit 122a adds “1” to the model counter m.

In step S304, the dissimilar model learning unit 122a determines whether the model counter m is the predetermined number M of models, or larger. More specifically, in a case where the model counter m is the number M of models or larger (YES in step S304), the processing proceeds to step S107. On the other hand, in a case where the model counter m is smaller than the number M of models (NO in step S304), the processing returns to step S302.

In this manner, the generated linear classification models are learned for each of the data groups so as to allow the feature values belonging to the data group to be classified as the specific class, enable the feature values to be included in the specific class at a high density, and prevent the linear classification models in the data group from resembling one another.

As a result, similar redundant linear classification models in each of the data groups can be reduced, and therefore a memory capacity required to detect an anomaly can be reduced by setting a small number as the number M of linear classification models with respect to each of the data groups in advance.

Next, a third exemplary embodiment for embodying the present invention will be described with reference to the drawings. Similar components to the individual components in the above-described first exemplary embodiment will be identified by the same reference numerals, and descriptions thereof will be omitted.

An anomaly detection system 1b according to the present exemplary embodiment will be described based on an example that uses boosting learning to set the parameters of the linear classification models for each of the data groups. In other words, an information processing apparatus 10b according to the present exemplary embodiment is different from the first exemplary embodiment in terms that the information processing apparatus 10b uses the boosting learning to set the parameters of the linear classification models for each of the data groups. In the present exemplary embodiment, the specific class is assumed to correspond to the normal class, and the class outside the specific class is assumed to correspond to the abnormal class, similarly to the first exemplary embodiment.

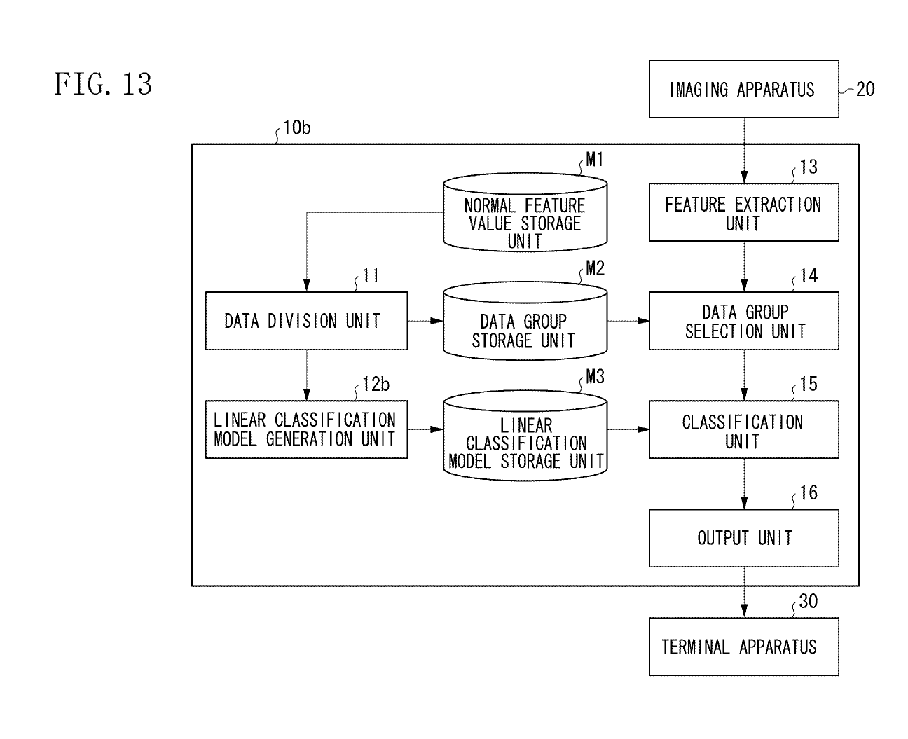

FIG. 13 is a configuration diagram illustrating an example of a configuration of the anomaly detection system 1b according to the third exemplary embodiment of the present invention. The anomaly detection system 1b includes the information processing apparatus 10b, the imaging apparatus 20, and the terminal apparatus 30, which are connected to one another by a network.

The information processing apparatus 10b is different from the information processing apparatus 10 according to the first exemplary embodiment in terms that the information processing apparatus 10b includes a linear classification model generation unit 12b.

The linear classification model generation unit 12b includes an importance assignment unit 121b, a model addition determination unit 122b, and a model addition unit 123b. Then, the linear classification model generation unit 12b generates a plurality of linear classification models for classifying the determination target data as the normal class or the abnormal class for each of the data groups based on the normal feature values stored in the normal feature value storage unit M1. Then, the linear classification model generation unit 12b causes the linear classification model storage unit M3 to store each of the generated linear classification models in such a manner that each of the generated linear classification models is associated with the linear classification model ID for identifying the linear classification model and the data group ID for identifying the data group that the linear classification model belongs to.

The importance assignment unit 121b assigns importance to the normal data based on a relationship between an already learned linear classification model and the normal feature value for each of the data groups. More specifically, the importance assignment unit 121b reads in, for each of the data groups, the normal feature values belonging to the data group from the normal feature value storage unit M1 according to the input of the trigger from the data division unit 11. Then, the importance assignment unit 121b assigns the importance to each normal data point in the data group based on the relationship with the already added linear classification model in the data group by a predetermined assignment method. Then, the importance assignment unit 121b outputs importance information, which indicates the importance assigned in association with the normal data ID, to the model addition determination unit 122b. For example, an average of distances between linear classification models added by the model addition unit 123b, which will be described below, and each normal data point is used for the method for assigning the importance to the normal data point. For example, an average of distances between the M linear classification models and an n-th normal data point can be calculated with use of the following expression (6):

$${\overline{d}}_{m , n} = {\sum }_{m = 1}^{M} {d}_{m , n} \\ {d}_{m , n} = \frac{\vert {w}_{m}^{T} {x}_{n} - {b}_{n} \vert}{‖ {w}_{m} ‖} . \qquad ( 6 )$$

In a case where not a single linear classification model is added to the data group, same importance may be assigned to all of the normal data pieces. The normal data located in the vicinity of the center of the data group is located far away from the linear classification models, whereby low importance may be assigned thereto in advance.

The model addition determination unit 122b determines whether a linear classification model should be added to the data group based on the importance of the normal data that is assigned by the importance assignment unit 121b. More specifically, according to the input of the importance information associated with the data ID from the importance assignment unit 121b, the model addition determination unit 122b determines whether to add a linear classification model to the data group based on the input importance information. As a method for determining whether to add a linear classification model, for example, the model addition determination unit 122b determines that a linear classification model should be added in a case where a variance of the importance or a difference between a maximum value and a minimum value is a predetermined threshold value or larger. In other words, the normal data with high importance assigned thereto is located far away from any of the linear classification models averagely, whereby the normal data may be unused to define the normal range in the feature space. Therefore, the model addition determination unit 122b determines that a linear classification model should be newly added.

The model addition unit 123b adds a linear classification model that allows the normal data belonging to the data group to be classified as the normal class and is located close to the normal data with the high importance assigned thereto. For example, the model addition unit 123b optimizes the parameters so as to minimize the following objective function equivalent to the one-class support vector machine with respect to the m-th linear classification model expressed as the expression (1):

$${min}_{{w}_{m}} \frac{1}{2} {‖ {w}_{m} ‖}^{2} + {( {w}_{m}^{T} {z}_{m} - {b}_{m} )}^{2} + C {\sum }_{n = 1}^{N} {l}_{n} {ξ}_{n} \\ s . t . \\ {w}_{m}^{T} {x}_{n} \geq {b}_{m} - {ξ}_{n} \\ n = 1 , 2 , … , N , \\ {ξ}_{n} \geq 0 , \qquad ( 7 )$$

where zₘ represents a normal data point having maximum importance in the data group, and a second term has a value proportional to a distance between the linear classification model (wₘ, bₘ) and the normal data point zₘ. In other words, the second term has the following nature. The value of the second term equals “0” in a case where the linear classification model (wₘ, bₘ) passes through the normal data point zₘ, and increases as the linear classification model (wₘ, bₘ) shifts away from the normal data point zₘ. As such, minimizing the entire objective function (the expression (7)) results in an increase in the number of normal feature values classified as the normal class (corresponding to a third term of the expression (7)) with respect to the m-th linear classification model. Further, the parameters can be optimized so as to allow the linear classification model to be located close to the normal data point zₘ having the maximum importance (corresponding to the second term of the expression (7)). As an optimization method, this problem can be sequentially solved with use of the steepest descent method or the like, similarly to the optimization problem expressed as the expression (4). When an amount of an update of the parameters falls to or below a predetermined threshold value for the update amount that is prepared in advance or the number of times of the update reaches or exceeds a predetermined threshold value for the number of times that is prepared in advance in each iteration of the steepest descent method, the update of the parameters by the steepest descent method is ended.

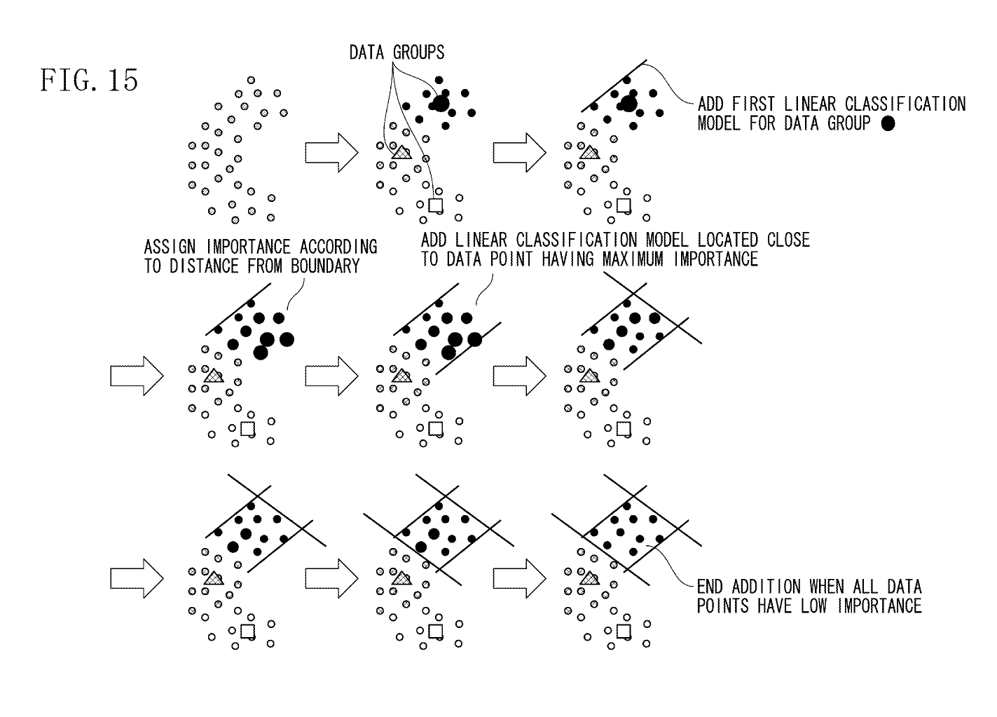

FIG. 15 illustrates an example of a process in which the information processing apparatus 10b adds the linear classification models with respect to a specific data group. As illustrated in FIG. 15, first, the information processing apparatus 10b divides the normal data into the plurality of data groups. Next, the information processing apparatus 10b adds a linear classification model to a certain data group, and assigns the importance to each of the normal data points belonging to the data group according to the distance from the linear classification model. Then, the information processing apparatus 10b sequentially adds a linear classification model located close to the normal data point with the high importance assigned thereto by solving the optimization problem expressed as the expression (7).

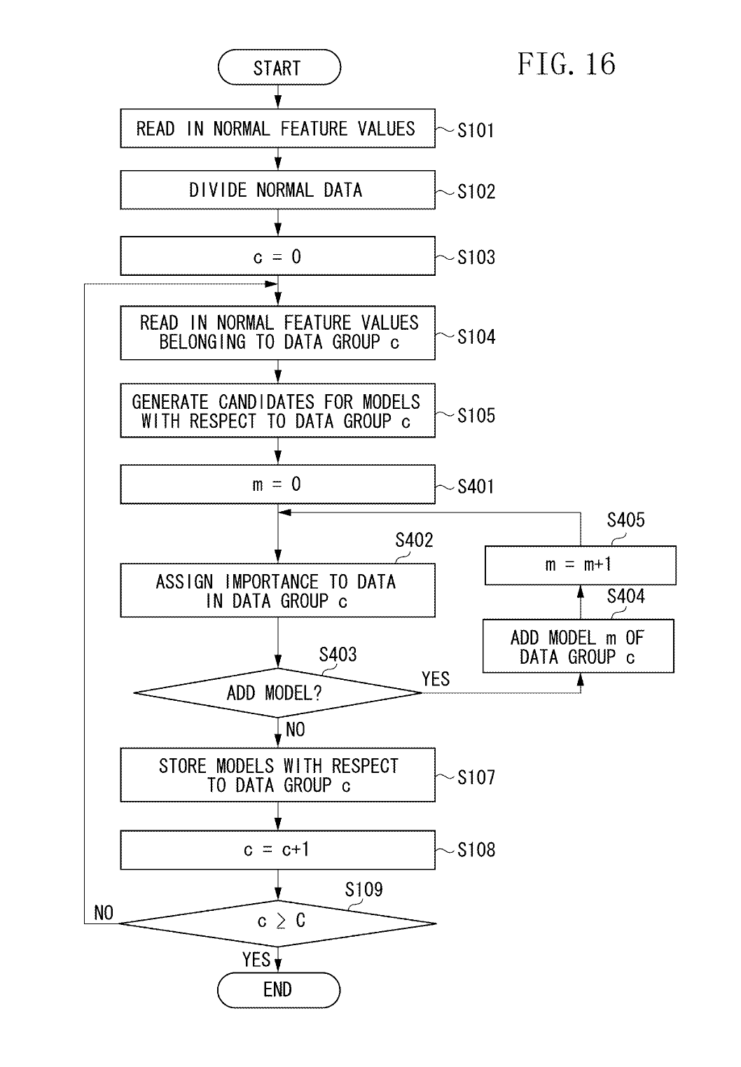

Next, an operation of the information processing apparatus 10b in the anomaly detection system 1b will be described with reference to FIG. 16. FIG. 16 is a flowchart illustrating an example of an operation of the anomaly detection system 1b according to the present exemplary embodiment for generating the linear classification models. Similar operations to the first exemplary embodiment will be identified by the same step numbers, and descriptions thereof will be omitted.

In step S401, the importance assignment unit 121b resets the model counter m. More specifically, the importance assignment unit 121b sets the model counter m to 0″.

In step S402, the importance assignment unit 121b assigns the importance to the normal data in the data group c. More specifically, the importance assignment unit 121b assigns the importance to the read normal data belonging to the data group c with use of the above-described predetermined method for assigning the importance. Then, the importance assignment unit 121b outputs the importance information assigned in association with the normal data ID, to the model addition determination unit 122b.

In step S403, the model addition determination unit 122b determines whether to add the linear classification model with respect to the data group c. More specifically, the model addition determination unit 122b determines whether to add the linear classification model with use of the above-described predetermined method for determining the addition according to the input of the importance information from the importance assignment unit 121b. In a case where the model addition determination unit 122b determines to add the linear classification model (YES in step S403), the model addition determination unit 122b outputs the input normal feature values and the importance information to the model addition unit 123b. Then, the processing proceeds to step S404. On the other hand, in a case where the model addition determination unit 122b determines not to add the linear classification model (NO in step S403), the processing proceeds to step S107.

In step S404, the model addition unit 123b adds the linear classification model with respect to the data group c. More specifically, the model addition unit 123b adds the linear classification model by the predetermined addition method according to the inputs of the normal feature values and the importance information associated with the data IDs from the model addition determination unit 122b.

In step S405, the model addition unit 123b adds “1” to the model counter m. Then, the processing returns to step S402.

In this manner, according to the present exemplary embodiment, the linear classification models can be added until all of the normal data pieces contribute to defining the normal range in the feature space with respect to each of the data groups. Accordingly, the number of linear classification models can be adjusted according to the size, the shape, and the like of the normal data range for each of the data groups. Therefore, an anomaly can be determined highly accurately even for a data group having a complicated normal range. Further, for a data group having a simple normal range, a small number of linear classification models are generated with respect thereto, so that the memory usage amount can be reduced and an anomaly can be determined speedily at the time of the classification.

Having described the exemplary embodiments of the present invention in detail with reference to the drawings, the specific configuration of the present invention is not limited to these exemplary embodiments, and the present invention also includes a design and the like within a range that does not deviate from the gist of the present invention. Further, each of the exemplary embodiments may be embodied in combination with any of the above-described individual exemplary embodiments.

Further, each of the above-described exemplary embodiments has been described as an exemplary embodiment of the present invention that addresses the issue regarding the anomaly detection by way of example, but the apparatus of the present invention can be applied to a general classification issue within the range that does not deviate from the gist of the present invention. For example, the apparatus of the present invention can be applied to an issue of detecting a human body from image data or video data with the specific class assumed to correspond to a human body class and the class outside the specific class assumed to correspond to another class than the human body class. Further, the apparatus of the present invention can be applied to an issue of classification into a large number of classes by using a plurality of information processing apparatuses according to the present invention.

Further, according to the above-described exemplary embodiments, each of the information processing apparatus 10, 10a, and 10b includes the normal feature value storage unit M1, the data group storage unit M2, and the linear classification model storage unit M3. However, a server connected via a network or another apparatus may include these components.

According to the present invention, it is possible to express a complicated normal data range with use of a classification model, and carry out highly accurate classification.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-242462, filed Nov. 28, 2014, which is hereby incorporated by reference herein in its entirety.

What is claimed is:

1. An information processing apparatus comprising:
a feature extraction unit configured to extract a feature value from input data;
a holding unit configured to, with respect to each of a plurality of groups acquired by dividing a plurality of feature values extracted from a plurality of training data pieces belonging to a specific class, hold characteristic information indicating a characteristic of a corresponding one of the plurality of groups, and a classification model;
a selection unit configured to select at least one group from the plurality of groups held by the holding unit based on the extracted feature value of the input data and the characteristic information; and
a determination unit configured to determine whether the input data belongs to the specific class with use of the classification model corresponding to the at least one group selected by the selection unit.

2. The information processing apparatus according to claim 1, wherein the determination unit determines, on the at least one group selected by the selection unit, whether the input data belongs to the specific class with use of the classification model corresponding to the at least one group selected by the selection unit, and
wherein, in a case where the determination unit determines that the input data belongs to the specific class in any of the selected groups, the determination unit determines that the input data belongs to the specific class.

3. The information processing apparatus according to claim 1, wherein the plurality of feature values is divided into the plurality of groups based on information relating to an environment under which the training data is acquired, and
wherein the holding unit holds the information relating to the environment under which the training data is acquired for each of the plurality of groups.

4. The information processing apparatus according to claim 3, wherein the selection unit acquires the information relating to an environment under which the input data is acquired, and selects the at least one group based on the feature value extracted from the input data and the information relating to an environment under which the input data is acquired.

5. The information processing apparatus according to claim 1, further comprising:
a characteristic information setting unit configured to divide the plurality of feature values extracted from the plurality of training data pieces into the plurality of groups, and set the characteristic information of each of the plurality of groups; and
a classification model generation unit configured to, with respect to each of the plurality of groups, generate the classification model based on feature value(s) included in a corresponding one of the plurality of groups.

6. The information processing apparatus according to claim 5, wherein the classification model generation unit randomly generates candidates for the classification model according to a predetermined probability distribution, with respect to each of the plurality of groups, and selects a candidate for the classification model that allows feature value(s) belonging to a corresponding one of the plurality of groups to be classified as the specific class and a density of the feature value(s) in the specific class to exceed a predetermined value, in each of the plurality of groups.

7. The information processing apparatus according to claim 6, wherein the probability distribution is set for each of the plurality of groups based on the characteristic information.

8. The information processing apparatus according to claim 6, wherein the classification model generation unit selects the candidate for the classification model further based on a degree of similarity between the candidates for the classification model.

9. The information processing apparatus according to claim 5, wherein the classification model generation unit includes
an importance assignment unit configured to, based on the classification model already generated for each of the plurality of groups and the feature value(s) belonging to a corresponding one of the plurality of groups, assign importance to the feature value(s),
a model addition determination unit configured to determine whether to add the classification model to the group based on the importance assigned by the importance assignment unit, and
a model addition unit configured to add the classification model based on the importance assigned by the importance assignment unit and the feature value(s) belonging to the corresponding one of the plurality of groups, in a case where the model addition determination unit determines to add the classification model to the corresponding one of the plurality of groups.

10. The information processing apparatus according to claim 1, wherein the characteristic information is a central coordinate of a plurality of feature values included in a corresponding one of the plurality of group in a feature space, or a variance-covariance matrix corresponding to the group.

11. An information processing method in an information processing apparatus including a holding unit configured to, with respect to each of a plurality of groups acquired by dividing a plurality of feature values extracted from a plurality of training data pieces belonging to a specific class, hold characteristic information indicating a characteristic of a corresponding one of the plurality of groups, and a classification model, the information processing method comprising:
extracting a feature value from input data;
selecting at least one group from the plurality of groups held by the holding unit based on the extracted feature value of the input data and the characteristic information; and
determining whether the input data belongs to the specific class with use of the classification model corresponding to the at least one group selected by the selecting.

12. A non-transitory computer-readable recording medium that stores a program for causing a computer to function as the units of an information processing apparatus comprising:
a feature extraction unit configured to extract a feature value from input data;
a holding unit configured to, with respect to each of a plurality of groups acquired by dividing a plurality of feature values extracted from a plurality of training data pieces belonging to a specific class, hold characteristic information indicating a characteristic of a corresponding one of the plurality of group, and a classification model;
a selection unit configured to select at least one group from the plurality of groups held by the holding unit based on the extracted feature value of the input data and the characteristic information; and
a determination unit configured to determine whether the input data belongs to the specific class with use of the classification model corresponding to the at least one group selected by the selection unit.
